(19) United States
(12) Patent Application Publication
(10) Pub. No.: US 2003/0116077 A1
(43) Pub. Date: Jun. 26, 2003

(54) Emergency signal system for vehicles

(76) Inventors: Louis R. Bucalo, San Francisco, CA (US); Brian D. Bucalo, Pompano, FL (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/033,471

(22) Filed: Dec. 26, 2001

(51) Int. Cl. B60Q 1/44

(52) U.S. Cl. 116/36

(57) ABSTRACT

A vehicle signaling system for alerting drivers approaching from a rear of a vehicle is provided which includes an audio signal emitting device, preferably arranged on the vehicle facing rearward, having an activated state in which an audio signal is emitted and an inactivated state in which an audio signal is not emitted. The system also includes velocity measurement means for measuring an absolute velocity of the vehicle, deceleration measurement means for measuring deceleration of the vehicle, the deceleration measurement means being operatively associated with the brake pedal of the vehicle such that deceleration of the vehicle is measured by the deceleration measurement means after the brake pedal is depressed, and control means coupled to the velocity measurement means and the deceleration measurement means for activating the audio signal emitting device from its inactivated state to its activated state only if the absolute velocity is greater than a threshold velocity in the control means and the measured deceleration is greater than a deceleration threshold in the control means. The system also includes means for enabling manual activation of the audio signal emitting device from the inactivated state to the activate state when the measured absolute velocity is less than a threshold velocity.

### FIELD OF THE INVENTION

The present invention relates generally to a vehicular emergency stopping signal system and, in particular, to an emergency stopping signal system which is intended to prevent rear-end collisions by alerting drivers that the automobile traveling in front of them is stopped or decelerating rapidly via audio signals.

### BACKGROUND OF THE INVENTION

At the present time, a serious problem exists with current vehicular braking or stopping signal systems. In particular, current signal systems are limited to light signals. Such light signal systems typically consist of brake lights that are activated by applying or pumping the brake pedal. Alternatively, light signal systems consist of red hazard flashers, which are activated manually by the driver.

Such light signal systems have several drawbacks. For example, such systems do not alert drivers who are not looking directly ahead of suddenly stopping or decelerating vehicles. A driver who is adjusting his or her radio or other instrument on the vehicle's dashboard, or who is simply not paying direct attention to the vehicle traveling ahead, is not alerted to a stopping or decelerating vehicle by a light signal system.

Moreover, light signal systems do not alert drivers to sudden decelerations when traveling at high velocities. Usually, when traveling at high velocities, such as on freeways, sudden deceleration of a vehicle is not adequately conveyed to drivers behind the vehicle by means of the usual brake lights on a vehicle. Rather, the drivers in the vehicles behind the decelerating vehicle may view the illumination of the brake lights as a small reduction in speed, which would be interpreted as not requiring a concomitant braking, as opposed to a large reduction in speed, which is obtained by a sudden deceleration and would require braking.

Systems have been developed which attempt to remedy the latter drawback discussed above. Specifically, applicants' own U.S. Pat. No. 5,786,752, the complete disclosure of which is incorporated herein by reference, discloses a signaling system for alerting drivers approaching from the rear of a vehicle which includes one or more novel light signals activated only when the vehicle traveling ahead is traveling at a velocity above a predetermined threshold velocity and when the vehicle traveling ahead is decelerating at a rate above a predetermined threshold deceleration. At any other conditions, the light signal(s) will not be activated. Thus, the activation of the novel light signal(s) will unequivocally alert drivers that the vehicle is decelerating rapidly and thus those drivers must also decelerate in order to avoid accidents. In this manner, a fully automatic emergency signal system is provided without a large potential for error, i.e., false indications of sudden deceleration, since there must be some affirmative action by the driver, i.e., applying pressure to the brake pedal, to activate the signal system in accordance with the invention, provided the vehicle is traveling above a certain velocity.

However, no attempts have been made at remedying the former drawback. Specifically, there exist no systems for alerting drivers of suddenly stopping or decelerating vehicles who are not looking ahead at those vehicles.

### OBJECTS AND SUMMARY OF THE INVENTION

It is therefore an object of the present invention to avoid the above drawbacks of the current signal systems.

It is another object of the present invention to provide methods and devices for creating a novel and prominent signal system for vehicles such as automobiles that will help prevent rear end collisions by rapidly and decisively alerting drivers approaching from the rear that the vehicle ahead is rapidly decelerating.

It is yet another object of the present invention to provide a new and improved emergency signal method and system for alerting drivers who are not looking ahead of suddenly stopping, stopped, or decelerating vehicles.

To achieve these objects, and others, a vehicle signaling system for alerting drivers approaching from a rear of a vehicle is provided which includes an audio signal emitting device, preferably arranged on the vehicle facing rearward, having an activated state in which an audio signal is emitted and an inactivated state in which an audio signal is not emitted. The system also includes velocity measurement means for measuring an absolute velocity of the vehicle, deceleration measurement means for measuring deceleration of the vehicle, the deceleration measurement means being operatively associated with the brake pedal of the vehicle such that deceleration of the vehicle is measured by the deceleration measurement means after the brake pedal is depressed, and control means coupled to the velocity measurement means and the deceleration measurement means for activating the audio signal emitting device from its inactivated state to its activated state only if the absolute velocity is greater than a threshold velocity in the control means and the measured deceleration is greater than a deceleration threshold in the control means.

The control means includes velocity threshold determining means coupled to the velocity measurement means for determining if the measured absolute velocity is greater than the threshold velocity. In addition, the control means includes deceleration threshold determining means coupled to the deceleration measurement means for determining if the measured deceleration is greater than the threshold deceleration. The velocity sensor includes, without limitation, a sensor operatively connected to the speedometer, engine, or transmission drive train, an air velocity or air pressure sensor to measure the relative velocity of outside airflow with respect to the vehicle, or a software subroutine in the vehicle's computer to calculate the vehicle's instantaneous velocity. The deceleration measurement means includes, without limitation, a velocity sensor coupled to the brake pedal for measuring the velocity with which the brake pedal is depressed, a deceleration measurement sensor connected to the brake pedal, a sensor coupled to the brake pedal for sensing the force applied to the brake pedal, a software subroutine in the vehicle's computer for calculating the vehicle's instantaneous deceleration, or an accelerometer.

The audio signal emitting device includes current automobile and vehicle horns as well as audio signal generating devices that produce novel audio signals. The audio signals would be directed substantially, though not necessarily exclusively, rearward so as to be audible to other vehicles approaching from behind the vehicle. The audio signal would be of sufficiently high level to be heard by drivers behind the vehicle at a reasonable distance in which to respond to the change in vehicle velocity. In one embodiment, the audio signal emitting device would be a unique, standardized horn sound that is directed substantially rearward from the vehicle. In another embodiment, the audio signal emitting device produces a unique loud sound or a series of novel horn sounds, or any sound that would grab the attention of the driver behind, such as a Morse code signal. The audio signal emitting device could be built into the rear of the vehicle's body or the rear bumper, or mounted on the undercarriage facing rearward. The decibel level of such an audio signal emitting device would be sufficiently loud so that drivers behind would be alerted quickly at a safe distance. The audio signal emitting device could be a compressed air horn or electromechanical horn.

In another embodiment of the invention, a vehicle signaling device for alerting drivers approaching from a rear of the vehicle is provided which includes an audio signal emitting device arranged on the vehicle having an activated state in which an audio signal is emitted and an inactivated state in which an audio signal is not emitted. The device includes means for enabling manual activation of the audio signal emitting device from the inactivated state to the activated state, velocity measurement means for measuring an absolute velocity of the vehicle, and control means coupled to the velocity measurement means and the manual activation enabling means. The control means enable activation of the audio signal emitting device from the inactivated state to the activated state by the manual activation enabling means if the measured absolute velocity is less than a threshold velocity.

In another embodiment of the invention, a vehicle signaling device for alerting drivers approaching from a rear of the vehicle is provided which includes an audio signal emitting device arranged on the vehicle having an activated state in which an audio signal is emitted and an inactivated state in which an audio signal is not emitted. The device includes means for enabling activation of the audio signal emitting device from the inactivated state to the activated state, velocity measurement means for measuring an absolute velocity of the vehicle, deceleration measurement means for measuring deceleration of the vehicle, and control means coupled to the deceleration measurement means and the velocity measurement means. The control means is coupled to the deceleration measurement means and is arranged to activate the audio signal emitting device from its inactivated state to its activated state if the absolute velocity is greater than the threshold velocity in the control means and the measured deceleration is greater than a deceleration threshold in the control means.

In another embodiment of the invention, a method for alerting drivers approaching from a rear of the vehicle to changes in the velocity of the vehicle is provided which includes the steps of arranging on the vehicle an audio signal emitting device having an inactivated state and an activated state in which an audio signal is emitted and controlling the activation of the audio signal emitting device in relation to the rate of change of velocity of the vehicle. The activation controlling step includes the steps of measuring an absolute velocity of the vehicle, measuring deceleration of the vehicle after a brake pedal of the vehicle is depressed, and activating the audio signal emitting device from its inactivated state to its activated state only if the absolute velocity is greater than a threshold velocity and the measured deceleration is greater than a deceleration threshold.

In another embodiment of the invention, a method for alerting drivers approaching from a rear of the vehicle to changes in the velocity of the vehicle is provided which includes the steps of arranging on the vehicle an audio signal emitting device having an inactivated state and an activated state in which an audio signal is emitted and controlling the activation of the audio signal emitting device in relation to the absolute velocity of the vehicle. The activation control step includes the steps of measuring an absolute velocity of the vehicle and enabling manual activation of the audio signal emitting device from the inactivated state to the activated state if the measured absolute velocity is less than a threshold velocity.

In another embodiment of the invention, a method for alerting drivers approaching from a rear of the vehicle to changes in the velocity of the vehicle is provided which includes the steps of arranging on the vehicle an audio signal emitting device having an inactivated state and an activated state in which an audio signal is emitted and controlling the activation of the audio signal emitting device in relation to the absolute velocity of the vehicle and the deceleration of the vehicle. The activation control step includes the steps of measuring an absolute velocity of the vehicle, measuring deceleration of the vehicle, and automatically activating the audio signal emitting device from its inactivated state to its activated state if the absolute velocity is greater than a threshold velocity and the measured deceleration is greater than a deceleration threshold.

These embodiments of the present invention solve the problem with current light signal systems, namely, alerting drivers who are not looking directly ahead of sudden decelerations of vehicles at high velocities. Specifically, a novel signaling device for alerting drivers approaching from a rear of the vehicle is provided which includes one or more audio signal emitting devices. The audio signals are activated automatically only when a vehicle is traveling at a velocity above a predetermined velocity, i.e., the threshold velocity, and the vehicle's deceleration, is above a predetermined deceleration, i.e., the threshold deceleration. The audio signal may also be activated manually when the measured velocity is below a threshold velocity. At any other conditions, the audio signal emitting device(s) will not be activated.

Thus, the activation of the audio signal emitting device(s) will unequivocally alert drivers, who may not be looking directly at the vehicle traveling ahead, that the vehicle is decelerating rapidly or stopped and that he or she must also decelerate in order to avoid accidents.

### BRIEF DESCRIPTION OF THE DRAWINGS

The following drawings are illustrative of embodiments of the invention and are not meant to limit the scope of the invention as encompassed by the claims.

FIG. 1 is a side view of a vehicle having a rear-mounted audio signal emitting device in accordance with the invention.

FIG. 2 is a rear perspective view of a vehicle having a standard three brake light system in which all three lights are simultaneously illuminated.

FIG. 3 is a schematic diagram of a sensing and control system for the audio signal emitting device systems in accordance with the invention.

### DETAILED DESCRIPTION OF THE INVENTION

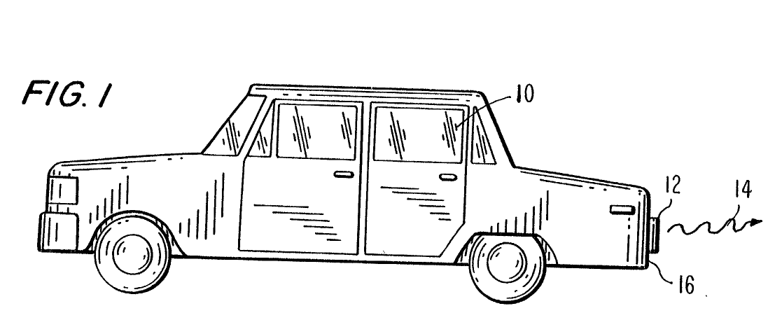

Referring to the accompanying drawings wherein the same reference numerals refer to the same or similar elements, in the embodiment of FIG. 1, an audio signal emitting device 12 is positioned on a rear element 16 of the vehicle 10, e.g., on the trunk or rear panel. The audio signal emitting device emits sound waves 14. Such sounds may be in the form of several types of sounds, including but not limited to, automobile horns or truck horn sounds, siren wails, human voices or other sounds. The types of sounds may be varied in presentation so that a series of loud horns could be followed by a loud siren wail. Sounds could be presented in a rapid series, such as a series of loud buzzes. Sound types could be intermixed. For example it is known that low frequency sounds carry farther than high frequency sounds and an audio signal could be comprised of low frequency sounds to preferentially alert drivers who are further behind, alternating with higher frequency sounds to preferentially alert drivers who are closer. Sounds traditionally associated with emergency stops such as a siren would be effective in grabbing the attention of the driver behind. Constant sounds of a continuous repeated nature, such as a single frequency, could be used since oncoming drivers would hear a Doppler shift in frequency as the relative velocity of the two vehicles changed during the deceleration of the car ahead. This Doppler shift would enhance the recognition of any rearward directed audio signal.

Audio signaling devices could be mounted on the rear bumper, incorporated into the chassis or body of the vehicle, or mounted on the undercarriage. Electromechanical horns or compressed air could be utilized. Compressed air horns could incorporate a visible gas component to enhance alerting the driver behind.

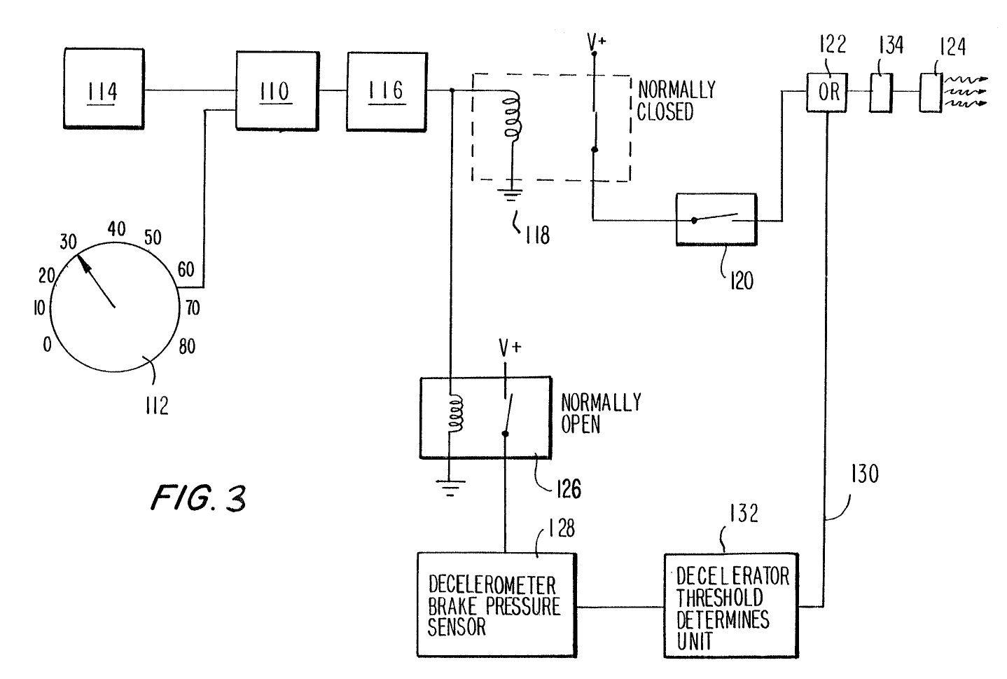

The audio signal emitting devices are connected to an actuation system such as described below with reference to FIG. 3.

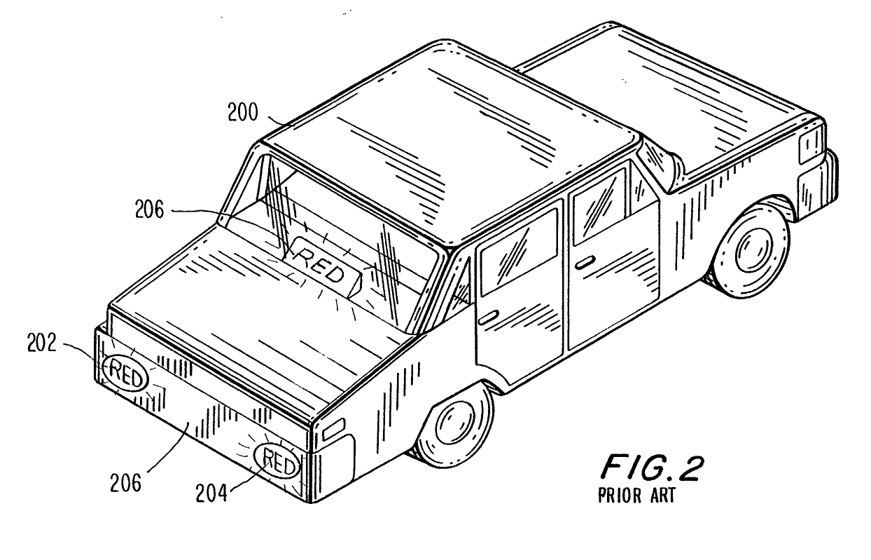

FIG. 2 shows a prior art braking system on a vehicle. The system includes three brake lights 202,204,206, two lights 202,204 on a rear panel 208 of the vehicle 200 and a third 206 in a central location above the trunk, and often within the vehicle interior compartment. As is conventional in the art, all three of these lights 202,204,206 illuminate at a standard illumination simultaneously upon depressing the brake pedal, regardless of the intensity of the force exerted on the brake pedal.

In accordance with each embodiment of the invention, a sensing and control system is coupled to the audio signal emitting devices. The sensing and control system or actuation means activates or prevents activation of the audio signal emitting devices. One embodiment of a sensing and control system is illustrated in FIG. 3 and comprises velocity measurement means such as a velocity sensor 110 connected to a speedometer 112 in the automobile, or alternatively to an integrating accelerometer 114, which senses and records the automobile's absolute velocity. When the absolute velocity of the automobile is sensed to be below a set threshold as determined by suitable determining/comparison means such as threshold detector 116 into which the set threshold is entered, a relay 118, which is coupled to the threshold detector 116 and normally closed, is de-energized thereby enabling manual switch 120 to activate an audio signal through an “or” gate 122.

Other means for enabling manual activation of the audio signal emitting device 124 on condition that the measured velocity is greater than the threshold velocity as determined by the threshold detector 116 can be used without deviating from the scope of the invention. The threshold detector 116, the relay 118, switch 120 and “or” gate 122 constitute parts of a control unit or control means for the audio signal 124. If the velocity of the automobile is above the threshold velocity, relay 118 is energized and the relay contacts become opened thereby preventing switch 120 from activating the audio signal emitting device 124 through the “or” gate 122, i.e., activation of switch 120 will not activate the audio signal emitting device 124. In this manner, the audio signal is prevented from being manually activated while the car is traveling at normal highway speeds. Such a feature prevents activation of the audio signal emitting device inadvertently or by intentional abuse of the warning system. If the car were to be stopped in traffic or traveling below the threshold speed, then relay 118 would be de-energized thereby enabling switch 120. The threshold speed could be selected to be an abnormal and unsafe low speed for highway, freeway and state and federal road driving. Upon enabling of switch 120, the audio signal emitting device 124 could then be activated manually by the driver of the vehicle to alert drivers approaching from the rear that the car is stopped or stopping in a traffic lane. It is understood that, in the same manner that audio signal emitting device 124 is activated, a plurality of such audio signal emitting devices could be activated simultaneously or sequentially to thereby achieve the objects of the invention. For example, the “or” gate could lead to several audio signal emitting devices 124 to provide for intermittent emission of a plurality of audio signals coupled thereto, e.g., in a sequential arrangement.

FIG. 3 also shows a second sensing and control system in accordance with the invention that can be used together with, or independent of, the sensing and control system described above. In this second sensing and control system, a relay 126, which is normally open, is controlled by the output of the threshold detector 116. If the vehicle is traveling above the threshold velocity, then relay 126 is also energized. This permits activation of sensor 128, i.e., the relay 126 constitutes a sensor activation mechanism. Sensor 128 may be of several types of detectors, which measure deceleration of the car. For example, sensor 128 may be a decelerometer, which measures the automobile's deceleration. Once the deceleration exceeds a certain threshold value as detected by a deceleration threshold determining unit 132 coupled to the deceleration measurement sensor 128, a signal is sent through wire 130 to the “or” gate 122 thereby activating the audio signal emitting device 124. As such, activation of the audio signal emitting device 124 is based on the measured velocity of the vehicle being greater than a velocity threshold and the deceleration of the vehicle being greater than a deceleration threshold. Also, in the embodiment wherein both sensing and control systems are operating, there are two ways in which the audio signal emitting device 124 can be activated, either manually when the measured velocity is less than the threshold velocity or automatically when the measured velocity is greater than the threshold velocity and the deceleration of the vehicle is greater than a deceleration threshold.

Deceleration measurement sensor 128 may be a strain gauge, pressure sensor, or velocity sensor operatively connected to the brake pedal thereby sensing the force and/or velocity with which the brake pedal is depressed. Strong pressure applied for a minimum, defined time interval on the brake pedal would correlate with a rapid deceleration and subsequently result in a signal being transmitted through wire 130 to actuate the “or” gate 122 and subsequently the audio signal emitting device 124. If the vehicle is traveling below the threshold velocity, relay 126 is de-energized thereby preventing activation of sensor 128 based on the deceleration of the vehicle. This prevents inadvertent activation of the audio signal generating means 124 at low speeds below the threshold speed or when stopped, such as when one applies pressure to the brake while stopped at a red light, based on a rapid deceleration or braking action.

The examples provided above are not meant to be exclusive. Many other variations of the present invention would be obvious to those skilled in the art, and are contemplated to be within the scope of the appended claims. For example, methods for alerting drivers approaching from a rear of the vehicle to changes in the velocity or rate of change in the velocity, e.g., deceleration, are contemplated. One such method comprises the steps of arranging on the rear of the vehicle an audio signal emitting device having an inactivated state and an activated state in which an audio signal is emitted and controlling the activation of the audio signal emitting device in relation to the rate of change of velocity of the vehicle. The activation controlling step includes the steps of measuring an absolute velocity of the vehicle, measuring deceleration of the vehicle after a brake pedal of the vehicle is depressed, and activating the audio signal emitting device from its inactivated state to its activated state only if the absolute velocity is greater than a threshold velocity and the measured deceleration is greater than a deceleration threshold.

Another method for alerting drivers approaching from a rear of the vehicle to changes in the velocity of the vehicle is provided which includes the steps of arranging on the rear of the vehicle an audio signal emitting device having an inactivated state and an activated state in which an audio signal is emitted and controlling the activation of the audio signal emitting device in relation to the absolute velocity of the vehicle and the deceleration of the vehicle. The activation control step includes the steps of measuring an absolute velocity of the vehicle, measuring deceleration of the vehicle, enabling manual activation of the audio signal emitting device from the inactivated state to the activated state if the measured absolute velocity is less than a threshold velocity, and automatically activating the audio signal emitting device from its inactivated state to its activated state if the absolute velocity is greater than the threshold velocity and the measured deceleration is greater than a deceleration threshold.

We claim:

1. A vehicle signaling device for alerting drivers approaching from a rear of the vehicle, the vehicle including a brake pedal, comprising
at least one audio signal emitting device arranged on the vehicle having an activated state in which an audio signal is emitted and an inactivated state in which an audio signal is not emitted,
velocity measurement means for measuring an absolute velocity of the vehicle,
deceleration measurement means for measuring deceleration of the vehicle, said deceleration measurement means being operatively associated with the brake pedal of the vehicle such that deceleration of the vehicle is measured by said deceleration measurement means after the brake pedal is depressed, and
control means coupled to said velocity measurement means and said deceleration measurement means for activating said at least one audio signal emitting device from its inactivated state to its activated state only if the absolute velocity is greater than a threshold velocity in said control means and the measured deceleration is greater than a deceleration threshold in said control means.

2. The device of claim 1, wherein said control means comprise velocity threshold determining means coupled to said velocity measurement means for determining if the measured velocity is greater than the threshold velocity, and deceleration threshold determining means coupled to said deceleration measurement means for determining if the measured deceleration is greater than the threshold deceleration.

3. The device of claim 1, wherein said deceleration measurement means comprises a velocity sensor coupled to the brake pedal for measuring the velocity with which the brake pedal is depressed.

4. The device of claim 1, wherein said deceleration measurement means comprises a deceleration measurement sensor connected to the brake pedal.

5. The device of claim 1, wherein said deceleration measurement means comprises a sensor coupled to the brake pedal for sensing the force applied to the brake pedal.

6. The device of claim 1, wherein said vehicle further comprises a computer and wherein said deceleration measurement means comprises a software subroutine in the computer.

7. The device of claim 1, wherein said deceleration measurement means comprises an accelerometer.

8. The device of claim 1, wherein said vehicle further comprises a speedometer, engine and transmission drive train and wherein said velocity sensor comprises a sensor operatively connected to one of either the speedometer, engine or transmission drive train of the vehicle.

9. The device of claim 1, wherein said velocity sensor comprises one of either an air velocity sensor or air pressure sensor which measures the velocity of the airflow outside of the vehicle relative to the vehicle.

10. The device of claim 1, wherein said vehicle further comprises a computer and wherein said velocity sensor comprises a software subroutine located in the computer of the vehicle which calculates the vehicle's instantaneous velocity.

11. The device of claim 1, wherein said audio signal comprises a vehicle horn.

12. The device of claim 1, wherein said audio signal comprises a siren.

13. The device of claim 1, wherein said audio signal comprises a human voice.

14. The device of claim 1, wherein said audio signal comprises a series of loud buzzes.

15. The device of claim 1, wherein said audio signal comprises low frequency sounds alternating with higher frequency sounds.

16. The device of claim 1, wherein said audio signal comprises compressed air.

17. The device of claim 1, wherein said audio signal comprises a repeating sound of a single frequency.

18. The device of claim 1, wherein said vehicle comprises a rear bumper and wherein said audio signal emitting device is arranged on the rear bumper of the vehicle.

19. The device of claim 1, wherein said audio signal emitting device is incorporated into the chassis or body of the vehicle.

20. The device of claim 1, wherein said audio signal emitting device is mounted on the undercarriage of the vehicle.

21. A vehicle signaling device for alerting drivers approaching from a rear of the vehicle, comprising
at least one audio signal emitting device arranged on the vehicle having an activated state in which an audio signal is emitted and an inactivated state in which an audio signal is not emitted,
means for enabling manual activation of said at least one audio signal emitting device from said inactivated state to said activated state,
velocity measurement means for measuring an absolute velocity of the vehicle, and
control means coupled to said velocity measurement means and said manual activation enabling means for enabling activation of said at least one audio signal emitting device from said inactivated state to said activated state by said manual activation enabling means if the measured absolute velocity is less than a threshold velocity in said control means.

22. A method for alerting drivers approaching from a rear of the vehicle to changes in the velocity of the vehicle, comprising the steps of:
arranging on the vehicle at least one audio signal emitting device having an inactivated state and an activated state in which an audio signal is emitted, and
controlling the activation of said at least one audio signal emitting device in relation to the rate of change of velocity of the vehicle, said activation controlling step comprising the steps of:
measuring an absolute velocity of the vehicle,
measuring deceleration of the vehicle after a brake pedal of the vehicle is depressed, and
activating said at least one audio signal emitting device from its inactivated state to its activated state only if the absolute velocity is greater than a threshold velocity and the measured deceleration is greater than a deceleration threshold.

23. A method for alerting drivers approaching from a rear of the vehicle to changes in the velocity of the vehicle, comprising the steps of:
arranging on the vehicle at least one audio signal emitting device having an inactivated state and an activated state in which an audio signal is emitted, and
controlling the activation of said at least one audio signal emitting device in relation to the absolute velocity of the vehicle, said activation control step comprising the steps of:
measuring an absolute velocity of the vehicle,
measuring deceleration of the vehicle after a brake pedal of the vehicle is depressed,
enabling manual activation of said at least one audio signal emitting device from said inactivated state to said activated state if the measured absolute velocity is less than a threshold velocity, and
automatically activating said at least one audio signal emitting device from its inactivated state to its activated state if the absolute velocity is greater than the threshold velocity and the measured deceleration is greater than a deceleration threshold.
